(19) United States
(12) Patent Application Publication
(10) Pub. No.: US 2013/0134073 A1
(43) Pub. Date: May 30, 2013

(54) Fine Separation Apparatus

(71) Applicants: Peter Jack Borota, Taylor, AZ (US); Craig Peterson Stevens, Caldwell, ID (US); Richard Lee Scarbrough, Taylor, AZ (US); Daniel Heath Hildebrand, Gilbert, AZ (US); Edward Jaye Ulrich, Taylor, AZ (US); Michael John Shoudt, Taylor, AZ (US)

(72) Inventors: Peter Jack Borota, Taylor, AZ (US); Craig Peterson Stevens, Caldwell, ID (US); Richard Lee Scarbrough, Taylor, AZ (US); Daniel Heath Hildebrand, Gilbert, AZ (US); Edward Jaye Ulrich, Taylor, AZ (US); Michael John Shoudt, Taylor, AZ (US)

(73) Assignee: Snowflake Power LLC, Snowflake, AZ (US)

(21) Appl. No.: 13/307,296

(22) Filed: Nov. 30, 2011

(51) Int. Cl. B07B 4/02; B07B 9/00

(52) U.S. Cl. 209/32; 209/134; 209/136; 209/34

(57) ABSTRACT

An apparatus for separating fine particles from an incoming stream of solid particles has a chute with openings that interface with respective inlets of a plenum. The incoming stream of solid particles enters the top of the chute. Nozzles direct gas jets into the chute transversely to the incoming stream of solid particles toward the openings. The gas jets blow the fine particles from the stream through the openings into the plenum. The remaining solid particles fall under gravity and exit the chute for further processing or disposal. The fine particles pass through the plenum under gravity and with the gas flow, exiting the plenum for disposal or further processing.

### FIELD OF THE INVENTION

The invention concerns an apparatus for separating fine particles from a stream of solid particles.

### BACKGROUND

In the processing of bulk solids it is often desirable to separate the particles comprising the bulk solids by some criteria so that the particles may be processed separately. For example, biomass derived combustibles, such as wood chips or plant matter, may be used as fuel for a boiler or burned for disposal, but such bulk solids are often contaminated with non-combustible fine particles, for example, silt, sand and dirt. If the non-combustible fine particles are not separated from the combustible particles prior to combustion they tend to foul boilers by forming solid nodules commonly called “clinkers” which must be removed periodically. Clinkers and other non-combusted deposits degrade the efficiency of the boiler and engender significant maintenance activity which could otherwise be avoided if the fine particles could be removed and disposed of prior to combustion of the combustible component of the bulk solid. There is clearly a need for an efficient and simple apparatus for separating fine particles from coarser particles in a stream of bulk solid matter to be processed.

### SUMMARY

The invention concerns an apparatus for separating fine particles from a material stream using at least one gas jet from a compressed gas source. In one example embodiment, the apparatus comprises a chute having a top and a bottom. The material stream enters the chute at the top and falls to the bottom under gravity. The chute has at least one opening positioned between its top and bottom. A plenum has an inlet that interfaces with the opening in the chute, thereby providing fluid communication between the chute and the plenum. The plenum has an outlet positioned distally to the inlet. At least one nozzle is positioned within the chute. The nozzle is in fluid communication with the compressed gas source. The nozzle points toward the opening in the chute and directs a gas jet transversely to the material stream. At least a portion of the fine particles within the stream are blown by the gas jet into the plenum inlet. The portion of the fine particles passes through the plenum to the plenum outlet.

The chute may be substantially vertically oriented. The plenum may also be substantially vertically oriented. In some embodiments the plenum is angularly oriented with respect to the chute. Depending upon its position within the chute the nozzle may point downwardly or upwardly toward the opening in the chute. The chute may be defined by a plurality of interconnected sidewalls. In this example embodiment, the opening is positioned in one of the sidewalls, and the nozzle is positioned on an oppositely disposed sidewall. The nozzle may comprise an orifice positioned in the oppositely disposed sidewall. In another embodiment, the nozzle is mounted on a tube extending through the chute. The tube may be oriented transversely to the chute, or it may be oriented perpendicularly to the chute. In some example embodiments the nozzle comprises an orifice positioned in a sidewall of the tube.

A sprinkler may be located within the plenum for spraying a liquid into the plenum. A filter may be aligned with the opening in the chute. The filter may comprise a screen mounted within the chute which covers the opening.

Another example embodiment of an apparatus for separating fine particles from a material stream using a plurality of gas jets from a compressed gas source comprises a chute having a top and a bottom. The material stream enters the chute at the top and falls to the bottom under gravity. A plurality of openings are positioned in the chute positioned in spaced relation from one another between the top and the bottom. A plenum has a plurality of inlets in spaced apart relation with one another. Each one of the inlets interfaces with a respective one of the openings in the chute thereby providing fluid communication between the chute and the plenum. The plenum has an outlet positioned distally to the inlet. A plurality of nozzles are positioned within the chute. The nozzles are in fluid communication with the compressed gas source. Each of the nozzles points toward at least one of the openings in the chute. Each of the nozzles directs one of the plurality of gas jets transversely to the material stream. At least a portion of the fine particles are blown by the gas jets into the plurality of plenum inlets. The portion of the fine particles passes through the plenum to the plenum outlet.

In one example embodiment, a first group of the nozzles point downwardly toward one of the openings in the chute. In another embodiment, a first group of the nozzles point upwardly toward one of the openings in the chute. The chute may be defined by a plurality of interconnected sidewalls. Each of the openings is positioned in one of the sidewalls. The plurality of nozzles are positioned on an oppositely disposed sidewall. One or more of the nozzles may comprise an orifice positioned in the oppositely disposed sidewall. In another example embodiment, the apparatus further comprises a plurality of tubes extending through the chute. In this embodiment, the nozzles are mounted on the tubes, and the tubes provide fluid communication between the nozzles and the compressed gas source.

Another example embodiment of an apparatus for separating fine particles from a material stream using a plurality of gas jets from a compressed gas source comprises a chute having a top and a bottom. The material stream enters the chute at the top and falls to the bottom under gravity. First and second openings are positioned in the chute in spaced relation from one another between the top and the bottom. A plenum has first and second inlets in spaced apart relation with one another. The first inlet interfaces with the first opening, the second inlet interfaces with the second opening and thereby provide fluid communication between the chute and the plenum. The plenum has an outlet positioned distally to the inlet. A plurality of first nozzles are positioned within the chute. The first nozzles are in fluid communication with the compressed gas source. Each of the first nozzles points downwardly toward the first opening in the chute. A plurality of second nozzles are positioned within the chute. The second nozzles are in fluid communication with the compressed gas source. Each of the second nozzles point upwardly toward the first opening in the chute. A plurality of third nozzles are positioned within the chute. The third nozzles are in fluid communication with the compressed gas source. Each of the third nozzles point downwardly toward the second opening in the chute. A plurality of fourth nozzles are positioned within the chute. The fourth nozzles are in fluid communication with the compressed gas source. Each of the fourth nozzles point upwardly toward the second opening in the chute. Each of the nozzles direct one gas jet transversely to the material stream. At least a portion of the fine particles are blown by the gas jets into the first and second plenum inlets. The portion of the fine particles pass through the plenum to the plenum outlet.

The chute may be defined by a plurality of interconnected sidewalls. The first and second openings are positioned in one of the sidewalls. The nozzles are positioned on an oppositely disposed sidewall. At least one of the nozzles may comprise an orifice positioned in the oppositely disposed sidewall. In another embodiment, a first tube extends through the chute. The first nozzles are mounted on the first tube. The first tube provides fluid communication between the first nozzles and the compressed gas source. A second tube extending through the chute. The second and the third nozzles are mounted on the second tube. The second tube provides fluid communication between the second and third nozzles and the compressed gas source. A third tube extends through the chute. The fourth nozzles are mounted on the third tube. The third tube provides fluid communication between the fourth nozzles and the compressed gas source.

### BRIEF DESCRIPTION OF THE DRAWINGS

FIG. 1 shows an elevational sectional view of an example fine separation apparatus according to the invention in conjunction with related ancillary equipment;

FIG. 2 shows a longitudinal sectional view of the example fine separation apparatus from FIG. 1 on an enlarged scale;

FIG. 3 shows an alternate embodiment of a fine separation apparatus according to the invention;

FIGS. 4-7 are isometric views of various example embodiments of portions of the fine separation apparatus according to the invention;

FIG. 8 is a cross sectional view taken at line 8-8 of FIG. 1; and

FIG. 9 is a cross sectional view taken at line 9-9 of FIG. 1.

### DETAILED DESCRIPTION

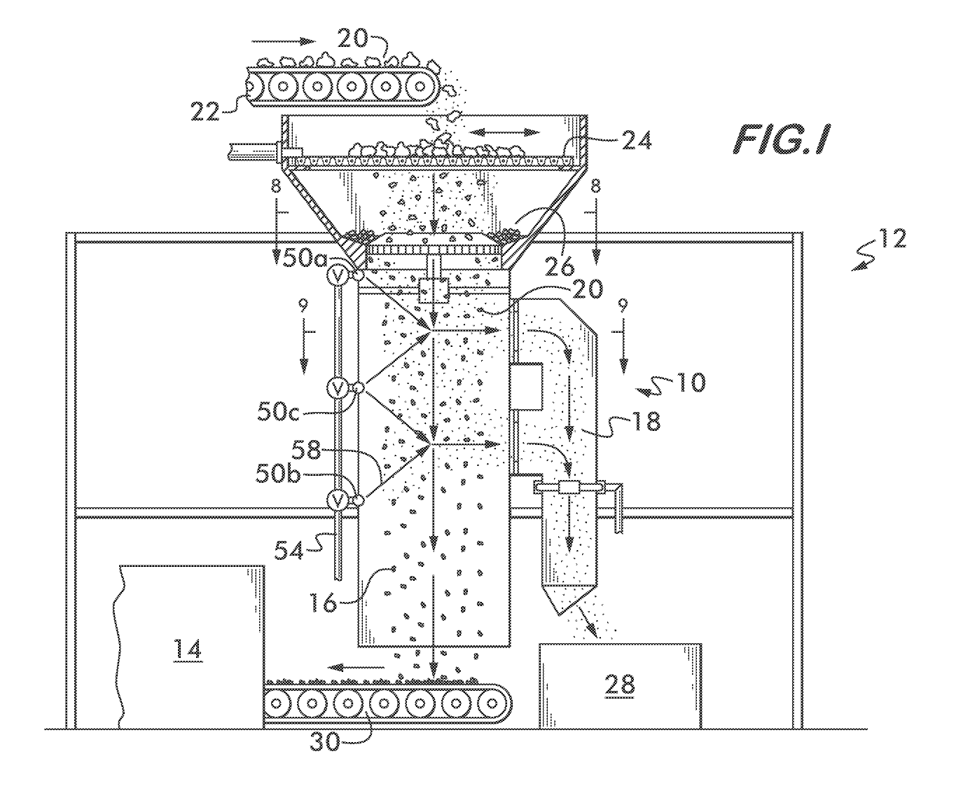

FIG. 1 shows an example fine separation apparatus 10 according to the invention installed within a system 12. In this example, system 12 feeds a boiler 14 with solid combustible biomass-derived material 16, for example wood chips, after substantially non-combustible fine particles 18, such as dirt, are separated by the apparatus 10 from an incoming material stream 20 comprising mixed fine particles and combustible biomass material.

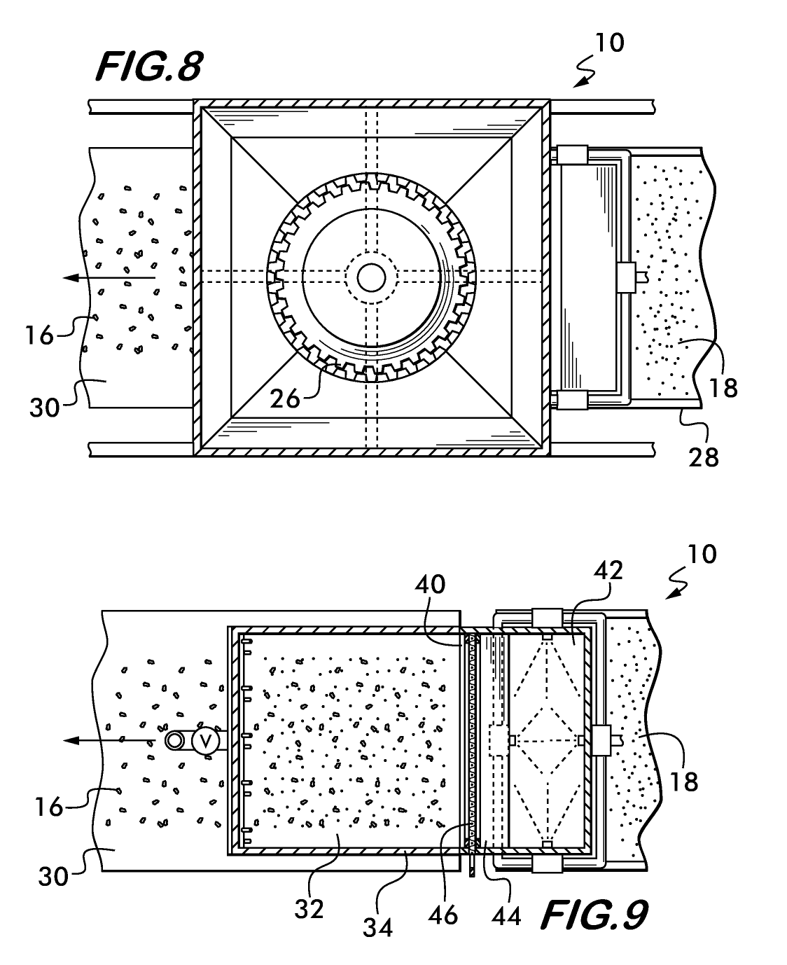

Incoming material stream 20 is transported from a storage pile (not shown) by a conveyor 22 to a sieve or “scalper” 24 which sorts the material 20 by size. Oversized material 20 is then passed to a grinding apparatus or hogger 26 (see also FIG. 8) where it is ground to a preferred size for efficient combustion. Wood chips, for example, are ground to a minimum size of ½ inch. The material stream 20 of mixed combustible material 16 and fine particles 18 proceeds to the separation apparatus 10 where the fine particles 18 are separated from the combustible material 16, the fine particles being deposited into a bin 28 for later disposal, the combustible material being received from the apparatus 10 by a conveyor 30 for transport to the boiler 14.

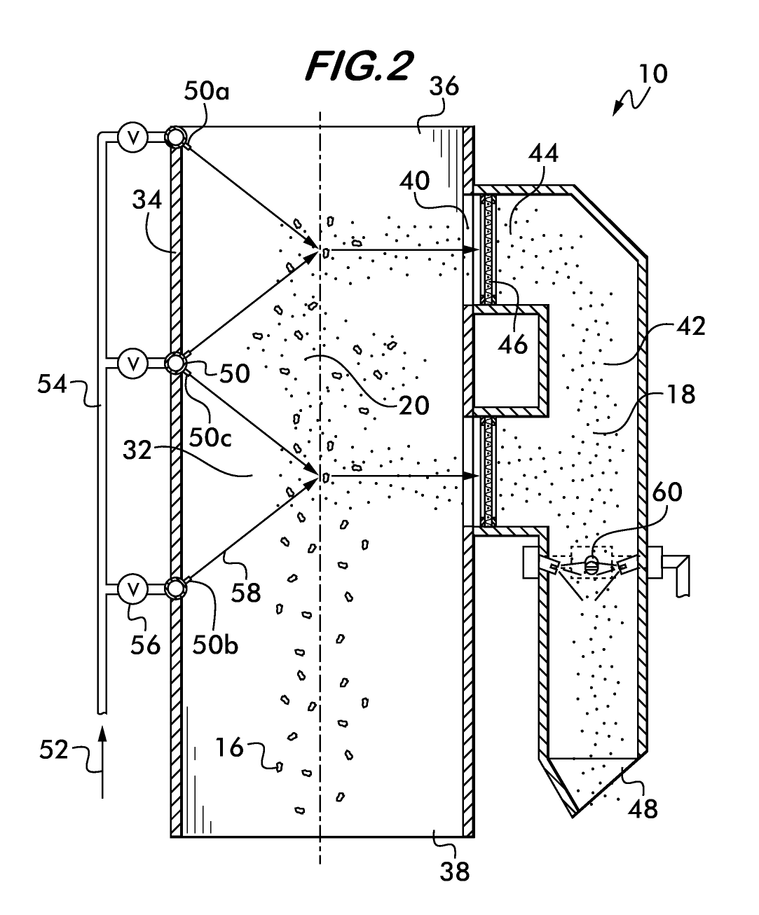

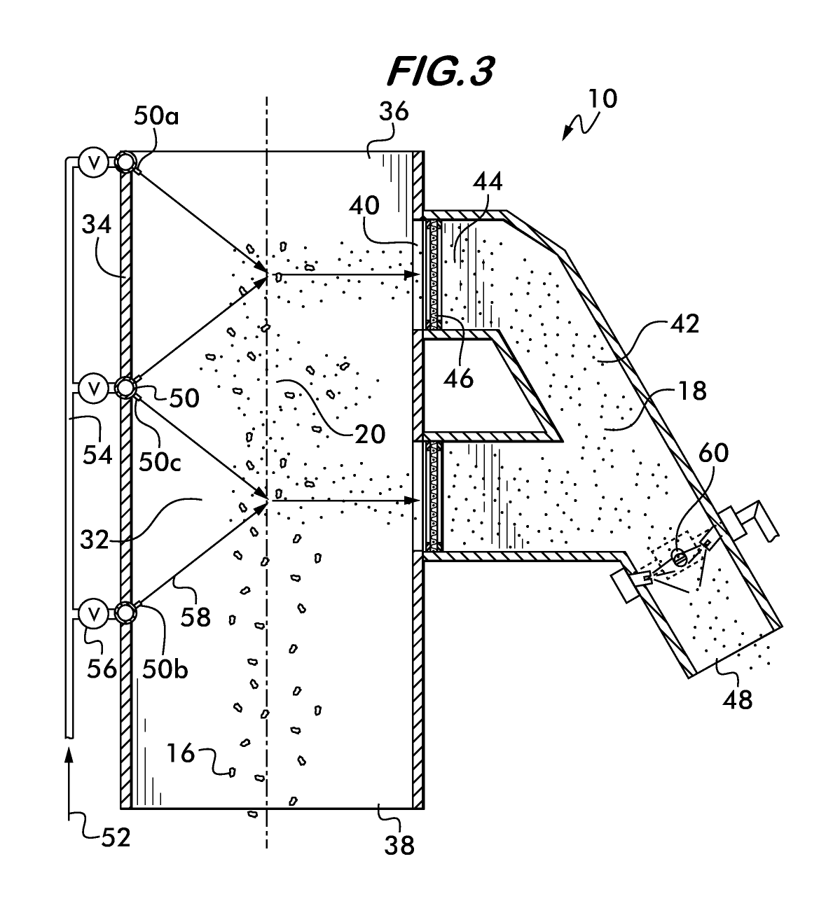

FIGS. 2 and 9 show an example separation apparatus 10 in detail. Apparatus 10 comprises a chute 32, in this example formed by a plurality of interconnected sidewalls 34. Chute 32 has a top 36 where the mixed material stream 20 enters, and a bottom 38 where the combustible material 16 exits, the combustible material falling through the chute under gravity. One or more openings 40 are positioned in one of the sidewalls 34 of chute 32 between the top 36 and the bottom 38. A plenum 42 has one or more inlets 44 interfacing with respective openings 40 in the chute 32, the openings providing fluid communication between the chute and the plenum. Respective filters 46, for example, screens, may be aligned with each opening 40 and positioned within the chute or between the chute and the plenum inlets 44 to prevent combustible material 16 from entering the plenum. Screens having mesh sizes between about ¼ inch and about ⅛ inch have proven effective at blocking combustible material while allowing fine particles to pass. Plenum 42 has an outlet 48 positioned distally to the inlet or inlets 44. In the example embodiment of apparatus 10 shown in FIG. 2, both the chute 32 and the plenum 44 are substantially vertically oriented. However, the plenum 42 may also be angularly oriented with respect to the chute as shown in FIG. 3.

As further shown in FIGS. 2 and 3, at least one, but preferably a plurality of nozzles 50 are positioned within the chute 32. Nozzles 50 are in fluid communication with a compressed gas source 52, in this example through a manifold 54, which may have a plurality of valves 56 for balancing the flow of compressed gas to the various nozzles. The compressed gas may be air, for example, and the compressed gas source 52 may comprise a dedicated compressor, shop air, compressed air from a tank, or a combination of these sources. Air pressure delivered to the nozzles 50 may be between about 80 psi and about 90 psi for effective operation of the apparatus 10. Nozzles 50 are positioned on a sidewall 34 of the chute opposite to the openings 40, and each nozzle points toward one of the openings, directing a gas jet 58 transversely to the material stream 20. Nozzles 50a, positioned above an opening 40 are pointed downwardly toward the opening. Nozzles 50b, positioned below an opening 40 are pointed upwardly toward the opening. For practical applications nozzles 50 deliver air at a speed and a volume flow rate to effectively separate the fine particles 18 from the combustible material 16 of the incoming material stream 20 by blowing the fine particles through the openings 40 (and the screens 46 if present) and into the plenum 42, where they are conveyed under gravity and airflow to the plenum outlet 48. Separation efficiencies of about 80% to about 90% of the fine particles have been or are expected to be achieved. The plenum 42 may be equipped with sprinklers 60 located downstream of the openings 40 in the chute 32. The sprinklers inject a liquid, such as water, into the stream of fine particles 18 to reduce airborne dust and to expedite exit of the fine particles from the plenum.

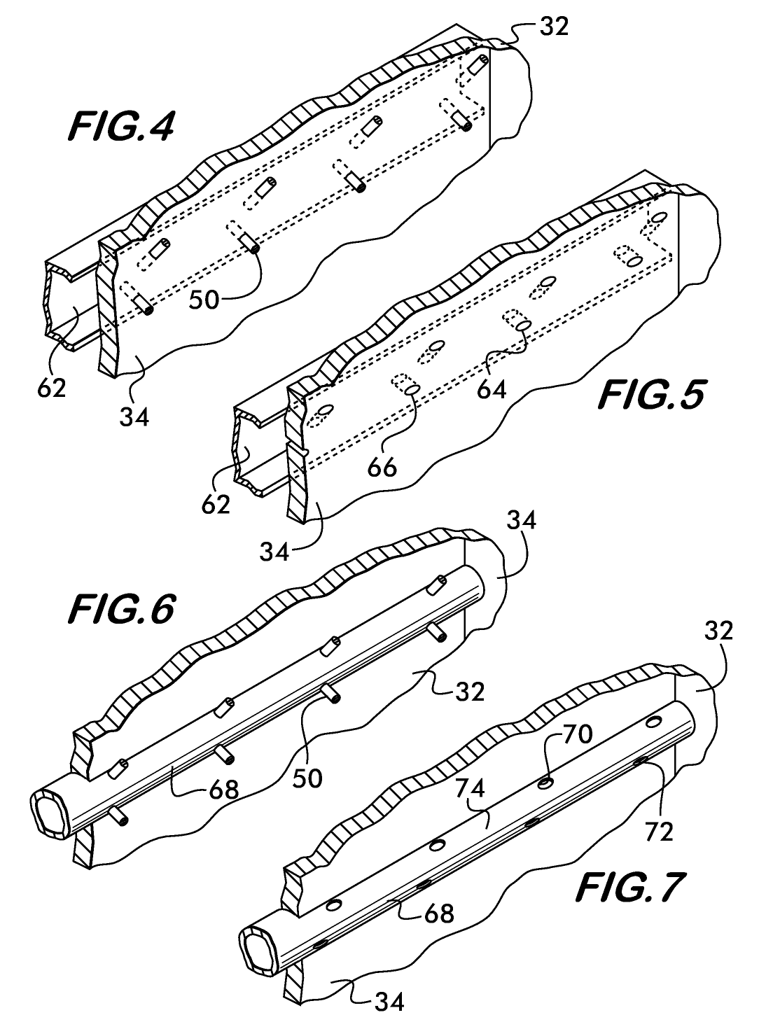

Nozzles 50 may take a variety of forms as shown in FIGS. 4-7. FIG. 4 shows a plurality of nozzles 50 mounted directly in a sidewall 34 of the chute 32. The nozzles extend from the sidewall into the chute and are fed compressed gas through a channel 62 located on an outside surface of the sidewall 34. The nozzles are angularly oriented so as to point toward openings in the chute sidewall and direct the gas jet so as to blow the fines into the plenum as described. FIG. 5 shows nozzles 64 in the form of orifices 66 located in the sidewall 34, the orifices being angularly oriented and fed compressed gas from a channel 62. FIG. 6 shows nozzles 50 mounted on a tube 68, the tube being mounted on the sidewall 34 of the chute 32 and fed compressed gas from the manifold 54 as shown in FIGS. 1 and 2. The tubes 68 may be mounted transversely to the chute. In the example embodiments shown herein, the tubes are mounted perpendicularly to the chute. FIG. 7 depicts another embodiment wherein nozzles 70 comprise orifices 72 located in the sidewall 74 of the tube 68, the tube being mounted on the sidewall 34 of the chute 32. It is found advantageous to position the nozzles in spaced relation horizontally along the chute sidewall at intervals of from about 4 inches to about 6 inches apart to provide an effective combination of air jets which direct the fine particles into the plenum. It is further advantageous to position groups of nozzles vertically within the chute. In the example embodiment shown in FIGS. 1 and 2, there are three groups of nozzles 50a, 50b and 50c, arranged such that gas jets 58 from at least two groups of nozzles are directed toward each opening 40 in chute 32. Other configurations are also feasible.

Devices according to the invention provide a simple and efficient apparatus for separating fine particles from an incoming material stream and thereby permit separate processing of the larger solid particles from the fine particles without the problems associated with the contamination of the fine particles with the larger particles. Although the invention is described for use in separating dirt or other such incombustible fine particles from larger, combustible particles, it is understood that this is by way of example only and the apparatus according to the invention may be used to separate fine particles from any bulk material stream.

What is claimed is:

1. An apparatus for separating fine particles from a material stream using at least one gas jet from a compressed gas source, said apparatus comprising:
a chute having a top and a bottom, said material stream entering said chute at said top and falling to said bottom under gravity;
at least one opening in said chute positioned between said top and said bottom;
a plenum having an inlet interfacing with said at least one opening in said chute thereby providing fluid communication between said chute and said plenum, said plenum having an outlet positioned distally to said inlet;
at least one nozzle positioned within said chute, said at least one nozzle being in fluid communication with said compressed gas source, said at least one nozzle pointing toward said at least one opening in said chute, said at least one nozzle directing said at least one gas jet transversely to said material stream, at least a portion of said fine particles being blown by said gas jet into said plenum inlet, said portion of said fine particles passing through said plenum to said plenum outlet.

2. The apparatus according to claim 1. wherein said chute is substantially vertically oriented.

3. The apparatus according to claim 2, wherein said plenum is substantially vertically oriented.

4. The apparatus according to claim 1, wherein said plenum is angularly oriented with respect to said chute.

5. The apparatus according to claim 1, wherein said at least one nozzle points downwardly toward said at least one opening in said chute.

6. The apparatus according to claim 1, wherein said at least one nozzle points upwardly toward said at least one opening.

7. The apparatus according to claim 1, wherein said chute is defined by a plurality of interconnected sidewalls, said at least one opening being positioned in one of said sidewalls, said at least one nozzle being positioned on an oppositely disposed sidewall.

8. The apparatus according to claim 7, wherein at least one of said nozzles comprises an orifice positioned in said oppositely disposed sidewall.

9. The apparatus according to claim 1, wherein said at least one nozzle is mounted on a tube extending through said chute.

10. The apparatus according to claim 9, wherein said tube is oriented transversely to said chute.

11. The apparatus according to claim 9, wherein said tube is oriented perpendicularly to said chute.

12. The apparatus according to claim 9, wherein said at least one nozzle comprises an orifice positioned in a sidewall of said tube.

13. The apparatus according to claim 1, further comprising at least one sprinkler located within said plenum, said at least one sprinkler for spraying a liquid into said plenum.

14. The apparatus according to claim 1, further comprising a filter aligned with said at least one opening in said chute.

15. The apparatus according to claim 14, wherein said filter comprises a screen mounted within said chute and covering said at least one opening.

16. An apparatus for separating fine particles from a material stream using a plurality of gas jets from a compressed gas source, said apparatus comprising:
a chute having a top and a bottom, said material stream entering said chute at said top and falling to said bottom under gravity;
a plurality of openings in said chute positioned in spaced relation from one another between said top and said bottom;
a plenum having a plurality of inlets in spaced apart relation with one another, each one of said inlets interfacing with a respective one of said openings in said chute thereby providing fluid communication between said chute and said plenum, said plenum having an outlet positioned distally to said inlet;
a plurality of nozzles positioned within said chute, said nozzles being in fluid communication with said compressed gas source, each of said nozzles pointing toward said at least one of said openings in said chute, each of said nozzles directing one of said plurality of gas jets transversely to said material stream, at least a portion of said fine particles being blown by said gas jets into said plurality of plenum inlets, said portion of said fine particles passing through said plenum to said plenum outlet.

17. The apparatus according to claim 16. wherein said chute is substantially vertically oriented.

18. The apparatus according to claim 17, wherein said plenum is substantially vertically oriented.

19. The apparatus according to claim 16, wherein said plenum is angularly oriented with respect to said chute.

20. The apparatus according to claim 16, wherein a first group of said nozzles point downwardly toward one of said openings in said chute.

21. The apparatus according to claim 16, wherein a first group of said nozzles point upwardly toward one of said openings.

22. The apparatus according to claim 16, wherein said chute is defined by a plurality of interconnected sidewalls, each of said openings being positioned in one of said sidewalls, said plurality of nozzles being positioned on an oppositely disposed sidewall.

23. The apparatus according to claim 22, wherein at least one of said nozzles comprises an orifice positioned in said oppositely disposed sidewall.

24. The apparatus according to claim 16, further comprising a plurality of tubes extending through said chute, said nozzles being mounted on said tubes, said tubes providing fluid communication between said nozzles and said compressed gas source.

25. The apparatus according to claim 24, wherein said tubes are oriented transversely to said chute.

26. The apparatus according to claim 24, wherein said tubes are oriented perpendicularly to said chute.

27. The apparatus according to claim 24, wherein at least one of said nozzles comprises an orifice positioned in a sidewall of one of said tubes.

28. The apparatus according to claim 16, further comprising a plurality of sprinklers located within said plenum, said sprinklers for spraying a liquid into said plenum.

29. The apparatus according to claim 16, further comprising a plurality of filters, each said filter being aligned with a respective one of said openings in said chute.

30. The apparatus according to claim 29, wherein each of said filters comprises a screen mounted within said chute and covering a respective one of said openings.

31. An apparatus for separating fine particles from a material stream using a plurality of gas jets from a compressed gas source, said apparatus comprising:
a chute having a top and a bottom, said material stream entering said chute at said top and falling to said bottom under gravity;
first and second openings in said chute positioned in spaced relation from one another between said top and said bottom;
a plenum having first and second inlets in spaced apart relation with one another, said first inlet interfacing with said first opening, said second inlet interfacing with said second opening and thereby providing fluid communication between said chute and said plenum, said plenum having an outlet positioned distally to said inlet;
a plurality of first nozzles positioned within said chute, said first nozzles being in fluid communication with said compressed gas source, each of said first nozzles pointing downwardly toward said first opening in said chute;
a plurality of second nozzles positioned within said chute, said second nozzles being in fluid communication with said compressed gas source, each of said second nozzles pointing upwardly toward said first opening in said chute;
a plurality of third nozzles positioned within said chute, said third nozzles being in fluid communication with said compressed gas source, each of said third nozzles pointing downwardly toward said second opening in said chute;
a plurality of fourth nozzles positioned within said chute, said fourth nozzles being in fluid communication with said compressed gas source, each of said fourth nozzles pointing upwardly toward said second opening in said chute; and wherein
each of said nozzles directing one said plurality of gas jets transversely to said material stream, at least a portion of said fine particles being blown by said gas jets into said first and second plenum inlets, said portion of said fine particles passing through said plenum to said plenum outlet.

32. The apparatus according to claim 31. wherein said chute is substantially vertically oriented.

33. The apparatus according to claim 32, wherein said plenum is substantially vertically oriented.

34. The apparatus according to claim 31, wherein said plenum is angularly oriented with respect to said chute.

35. The apparatus according to claim 31, wherein said chute is defined by a plurality of interconnected sidewalls, said first and second openings being positioned in one of said sidewalls, said nozzles being positioned on an oppositely disposed sidewall.

36. The apparatus according to claim 35, wherein at least one of said nozzles comprises an orifice positioned in said oppositely disposed sidewall.

37. The apparatus according to claim 31, further comprising:
a first tube extending through said chute, said first nozzles being mounted on said first tube, said first tube providing fluid communication between said first nozzles and said compressed gas source;
a second tube extending through said chute, said second and said third nozzles being mounted on said second tube, said second tube providing fluid communication between said second and third nozzles and said compressed gas source;
a third tube extending through said chute, said fourth nozzles being mounted on said third tube, said third tube providing fluid communication between said fourth nozzles and said compressed gas source.

38. The apparatus according to claim 37, wherein said tubes are oriented transversely to said chute.

39. The apparatus according to claim 37, wherein said tubes are oriented perpendicularly to said chute.

40. The apparatus according to claim 37, wherein at least one of said nozzles comprises an orifice positioned in a sidewall of one of said tubes.

41. The apparatus according to claim 31, further comprising a plurality of sprinklers located within said plenum, said sprinklers for spraying a liquid into said plenum.

42. The apparatus according to claim 31, further comprising:
a first filter aligned with said first openings in said chute;
a second filter aligned with said second opening in said chute.

43. The apparatus according to claim 42, wherein:
said first filter comprises a first screen mounted within said chute and covering said first opening;
said second filter comprises a second screen mounted within said chute and covering said second opening.
